(19) United States
(12) Patent Application Publication
(10) Pub. No.: US 2017/0326434 A1
(43) Pub. Date: Nov. 16, 2017

(54) "L" Shaped Bracket for Skateboard Lights

(71) Applicant: Michael Gene Faeth, Fresno, CA (US)

(72) Inventor: Michael Gene Faeth, Fresno, CA (US)

(21) Appl. No.: 15/591,117

(22) Filed: May 10, 2017

Related U.S. Application Data
(60) Provisional application No. 62/334,378, filed on May 10, 2016.

(51) Int. Cl. A63C 17/26; F16M 13/02; F16B 2/20; F21V 21/088

(52) U.S. Cl. CPC A63C 17/26; F21V 21/088; F16M 13/022; F16B 2/20; A63C 2203/14

(57) ABSTRACT

An “L” shaped bracket is disclosed that is mounted onto a skateboard truck mounting base using one pre-existing corner bolt that provides a means to mount a clip which holds a removable light. The light casts illumination towards the front and/or back of the board allowing the skateboarder to see a path in front of them in the dark and to be visible to others.

### RELATED APPLICATIONS

The present application claims the benefit of U.S. provisional patent application No. 62/334,378 filed on May 10, 2016 and incorporated herein in its entirety.

### BACKGROUND OF THE INVENTION

It is the case that many skateboarders ride at night and this is dangerous because of not being visible to others and not being able to see well enough to avoid obstacles in their path. A strong need exists for skateboarders to have a method of attaching lights to their skateboards for riding at night. It is common place for cyclists to have lights on their bicycles, but this is not the case for skateboarders. So there needs to be a simple way for skateboarders to add headlights and taillights to their boards. One alternative to adding lights to skateboards that illuminate the path is decorative types of lighting: flashing lights or multicolored lights attached somewhere on the skateboard. While these types of lights solve the issue of being seen, they do not provide the user with a substantial enough amount of light to illuminate the route being taken. Although there are skateboard lights being manufactured to serve as a headlight, the methods used for mounting such lights to the board are not desirable due to various reasons: the light is positioned too far away from the truck base when mounted, the trucks need to be completely removed in order to mount a riser fitted with a light, multiple truck bolts need to be removed to mount a bracket or multiple brackets or altering the skateboard to an undesirable degree such as drilling holes into the board is required. Therefore, it would be beneficial for there to be a method of attaching a light to a skateboard that does not require multiple truck bolts or the entire truck to be removed, undesirable alterations to be made to the skateboard, nor that positions the light far away from the truck base.

### TECHNICAL FIELD OF THE INVENTION

The present invention relates to a method of attaching a removable light to a skateboard from one pre-existing truck bolt.

### BRIEF SUMMARY OF THE INVENTION

An “L” shaped bracket specifically designed to have one arm include a single hole that allows a standard bolt and nut to be used to mount a mounting clip of your choice. Any light can be used that is designed to lock into such a mounting clip. The other arm of the “L” brackets includes an elongated screw hole, to allow the first arm to reach the front of a truck mounting base even if the mounting holes are positioned differently on the truck base. The present invention provides an “L” shaped bracket to allow a light to be fastened to a skateboard using one pre-existing truck bolt. The overall design provides the user with a bracket that can be fitted to many different truck configurations. The bracket positions the light center of board and as close to the truck base as possible. It allows for a broad light to be configured to run perpendicularly to the length of the board. These and other features and advantages of the present invention will become apparent from the following description, drawings and claims.

### BRIEF DESCRIPTION OF THE DRAWINGS

FIG. 1 is a perspective of an “L” shaped bracket showing a single hole on one arm and an elongated screw hole on the other.

FIG. 2 is a bottom perspective of a skateboard with the bracket attached to one mounting bolt.

FIG. 3 shows the same as FIG. 2. except a different mounting hole configuration is used on the truck mounting base.

FIG. 4 shows how any mounting clip manufactured with a standard screw hole can attach to only one pre-existing truck bolt.

FIG. 5 shows how any light can be used to attach to a skateboard if the mounting clip it fits into uses a standard screw hole to attach to the bracket.

### DETAILED DESCRIPTION OF THE EMBODIMENTS

An “L” shaped bracket is provided that has an elongated screw hole on one of the arms and a single screw hole on the other arm. The arm with the elongated screw hole attaches to a skateboard truck and the single screw hole allows for a mounting clip to be fastened to the bracket. The mounting clip is designed to securely hold the light in place while skating and yet allows it to be released when needed for recharging. The bracket, clip and light assembly provides the user a method in which to attach a light to a skateboard truck. There are variations in the mounting bases of trucks and the elongated screw hole allows for one bracket to fit most of these different configurations. In addition, the overall design of the bracket provides the user with an easy way of attaching a light, specifically from one corner only and effectively positioning a light center of board, all the while keeping the light source as close to the mounting base as possible so as to leave clearance between the trucks and front/back of the board. The bracket attaches using only one pre-existing truck bolt and avoids the need for hardware to be added or removed from the board or for any modifications to be made, such as drilling holes into the board.

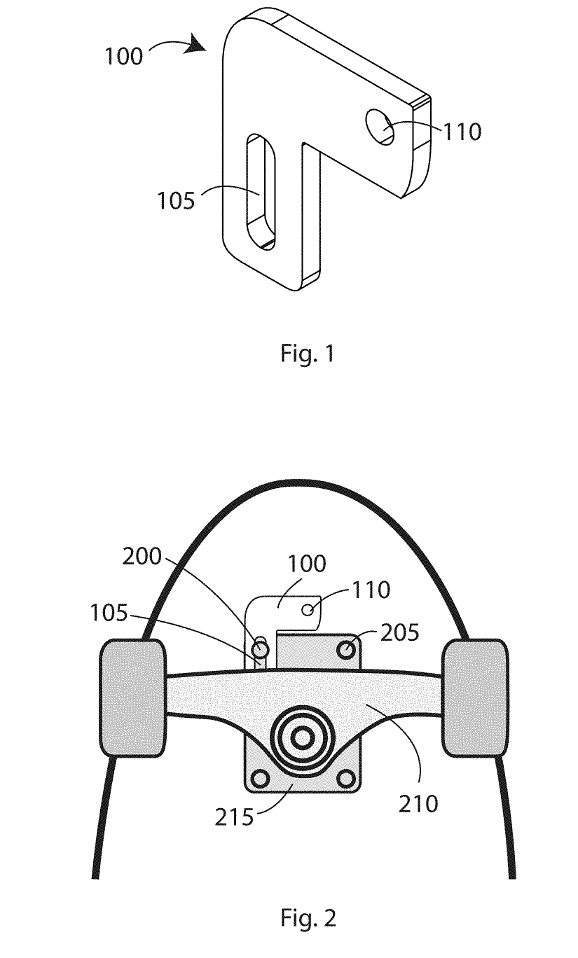

FIG. 1. shows the “L” shaped bracket 100, an elongated screw hole 105 and a standard screw hole 110

FIG. 2. shows pre-existing truck bolts 200 and 205 used to mount a skateboard truck 210 from the mounting base plate 215.

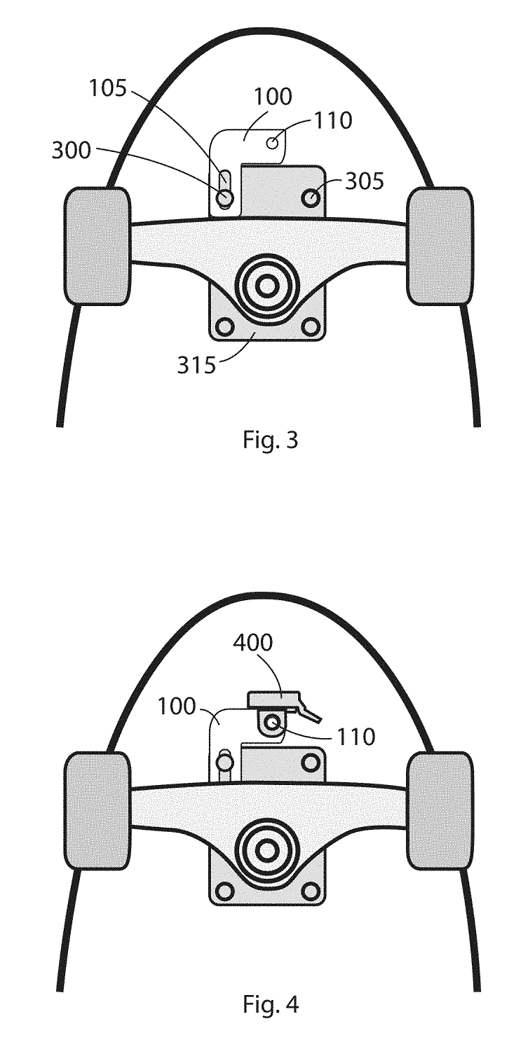

FIG. 3. shows the same configuration of FIG. 2. except the mounting bolts 300 and 305 are positioned further away from the edge of the mounting base plate 315.

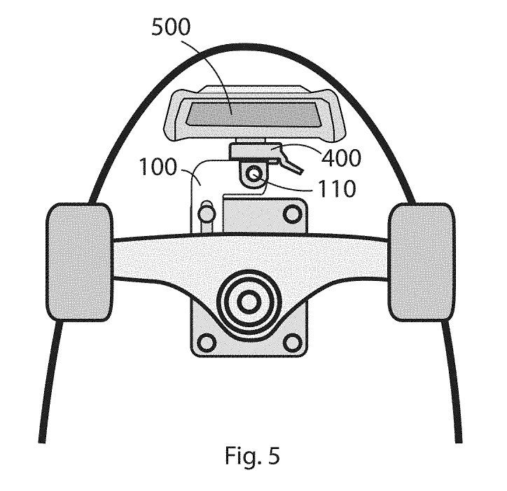

FIG. 4. shows a clip 400 that is attached to the mounting bracket using a common bolt and nut method of attachment.

FIG. 5. shows a light 500 that is attached to the clip 400. The clip and light combination can be of any design that can be attached to the bracket using the standard screw hole 110.

What is claimed is:

1. An “L” shaped bracket comprising:
a) a first arm having an elongated screw slot for engagement with one pre-existing truck bolt
b) a second arm having a standard screw slot for engagement with a mounting clip

2. The bracket of claim 1, wherein second arm is positioned orthogonally to the first arm

3. The bracket of claim 1, wherein a mounting clip is fastened to the second arm

4. The bracket and clip combination of claim 3, wherein a removable light is clipped into the mounting clip

5. The bracket of claim 1, wherein the material used to create the bracket is strong enough to withstand the rigors of skateboarding, such as steel, composite, nanofiber, etc.

6. The bracket of claim 1, wherein the light effectively ends up center of board and is tucked in a closely as possible to the truck.

7. The bracket of claim 1, wherein the mounting clip is fabricated to the bracket as one piece
